(19) United States
(12) Patent Application Publication
(10) Pub. No.: US 2025/0124442 A1
(43) Pub. Date: Apr. 17, 2025

(54) SYSTEMS AND METHODS FOR RISK SIGNAL COLLECTION AND SHIFTING FRAUD RESPONSIBILITY

(71) Applicant: Capital One Services, LLC, McLean, VA (US)

(72) Inventors: Jeffrey RULE, Chevy Chase, MD (US); Lawrence DOUGLAS, McLean, VA (US); Jackson MACOMBER, Henrico, VA (US)

(73) Assignee: Capital One Services, LLC, McLean, VA (US)

(21) Appl. No.: 18/915,515

(22) Filed: Oct. 15, 2024

Related U.S. Application Data
(60) Provisional application No. 63/544,250, filed on Oct. 16, 2023.
(60) Provisional application No. 63/544,248, filed on Oct. 16, 2023.

(51) Int. Cl. G06Q 20/40; G06Q 20/32; G06Q 20/38

(52) U.S. Cl. CPC G06Q 20/4016; G06Q 20/3224; G06Q 20/3821

(57) ABSTRACT

Systems and methods for generating security assessments for user-based transactions. A central processor application can receive data from a merchant website outfitted with a software development kit and/or a browser extension designed to gather information about the user from the merchant checkout page. The central processor application can perform, using a trained predictive model, a security assessment of the transaction and shift fraud responsibility from the merchant to a bank or account provider based on the security assessment.

### CROSS-REFERENCE TO RELATED APPLICATIONS

This application claims the priority of U.S. Provisional Patent Application No. 63/544,250, filed Oct. 16, 2023, and U.S. Provisional Patent Application No. 63/544,248, filed Oct. 16, 2023, the contents of which are incorporated herein by reference in their entireties.

### FIELD OF THE DISCLOSURE

The present disclosure relates to systems and methods for risk signal collection and shifting the responsibility to absorb losses associated with fraudulent transactions.

### BACKGROUND

Credit card transactions are ubiquitous in society and consumers often carry multiple credits cards at any time. As credit card transactions increase, so do the opportunities for fraud. Fraudulent transactions can cause significant losses, and fraudulent actors are constantly attempting fraudulent transaction. Fraudulent actors seek to perform fraudulent transactions by applying known methods and by attempting new methods. Accordingly, fraud prevention and reduction efforts must be diligent and constantly evolving.

Currently, merchants frequently bear the responsibility for the losses incurred by fraud for credit card transactions. This is because merchants cannot control how customers handle their cards or how the card information is stored by the issuing entities, banks, and/or account providers associated with the cards. As a result, even though merchants implement security measures, merchants often have to absorb the losses associated with fraudulent transactions.

These and other deficiencies exist. Therefore, there is a need to provide systems and methods that overcome these deficiencies provide for risk signal collection and shifting responsibility for the losses associated with fraudulent transactions.

### SUMMARY OF THE DISCLOSURE

In some aspects, the techniques described herein relate to a system including: a central processor application configured to: collect, from a merchant processor, transaction profile information associated with an online transaction; analyze the transaction profile information; determine, based on the analysis of the transaction profile information, a security assessment of the online transaction, wherein the security assessment indicates a measure of security associated with the online transaction; generate a fraud responsibility transfer request; transmit the fraud responsibility transfer request to the merchant processor; receive, from the merchant processor, an acceptance response including an agreement to transfer a fraud responsibility to the central processor application; and perform, based on the acceptance response, a checkout process for the online transaction, wherein the merchant processor shifts the fraud responsibility to the central processor application.

In some aspects, the techniques described herein relate to a method including: collecting, by a central processor application from a merchant processor, transaction profile information associated with an online transaction; analyzing, by the central processor application, the transaction profile information; determining, by the central processor application based on the analysis of the transaction profile information, a security assessment of the online transaction, wherein the security assessment indicates a measure of security associated with the online transaction; generating, by the central processor application, a fraud responsibility transfer request; transmitting the fraud responsibility transfer request to the merchant processor; receiving, from the merchant processor, an acceptance response including an agreement to transfer a fraud responsibility to the central processor; performing, based on the acceptance response, a checkout process for the online transaction, wherein the merchant processor shifts the fraud responsibility to the central processor application.

In some aspects, the techniques described herein relate to a non-transitory computer readable medium containing computer executable instructions that, when executed by a device comprising a processor, cause the device to perform procedures including: collecting, from a merchant processor, transaction profile information associated with an online transaction; analyzing the transaction profile information; determining, based on the analysis of the transaction profile information, a security assessment of the online transaction, wherein the security assessment indicates a measure of security associated with the online transaction; generating a fraud responsibility transfer request; transmitting the fraud responsibility transfer request to the merchant processor; receiving, from the merchant processor, an acceptance response including an agreement to transfer a fraud responsibility; performing, based on the acceptance response, a checkout process for the online transaction, wherein the merchant processor shifts the fraud responsibility to the central processor application.

In some aspects, the techniques described herein relate to a system including: a central processor application configured to: collect, from a browser extension associated with a merchant, transaction profile information associated with an online transaction; analyze the transaction profile information; determine, based on the analysis of the transaction profile information, a security assessment of the online transaction, wherein the security assessment indicates a measure of security associated with the online transaction; generate a fraud responsibility transfer request; transmit the fraud responsibility transfer request to the merchant processor; receive, from the browser extension, an acceptance response including an agreement to transfer a fraud responsibility to the central processor application; and perform, based on the acceptance response, a checkout process for the online transaction, wherein the browser extension shifts the fraud responsibility to the central processor application.

In some aspects, the techniques described herein relate to a method including: collecting, by a central processor application from a browser extension associated with a merchant, transaction profile information associated with an online transaction; analyzing, by the central processor application, the transaction profile information; determining, by the central processor application based on the analysis of the transaction profile information, a security assessment of the online transaction, wherein the security assessment indicates a measure of security associated with the online transaction; generating, by the central processor application, a fraud responsibility transfer request; transmitting the fraud responsibility transfer request to the browser extension; receiving, from the browser extension, an acceptance response including an agreement to transfer a fraud responsibility to the central processor; and performing, based on the acceptance response, a checkout process for the online transaction, wherein the browser extension shifts the fraud responsibility to the central processor application.

In some aspects, the techniques described herein relate to a non-transitory computer readable medium containing computer executable instructions that, when executed by a device including a processor, configure the processor to perform procedures including: collecting, from a browser extension associated with a merchant, transaction profile information associated with an online transaction; analyzing the transaction profile information; determining, based on the analysis of the transaction profile information, a security assessment of the online transaction, wherein the security assessment indicates a measure of security associated with the online transaction; generating a fraud responsibility transfer request; transmitting the fraud responsibility transfer request to the browser extension; receiving, from the browser extension, an acceptance response including an agreement to transfer a fraud responsibility; and performing, based on the acceptance response, a checkout process for the online transaction, wherein the browser extension shifts the fraud responsibility from the merchant to an account provider.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments of the invention.

FIG. 1 illustrates a system according to an exemplary embodiment.

FIGS. 2A and 2B are flowcharts illustrating methods according to an exemplary embodiment.

FIGS. 3A and 3B are sequence diagrams illustrating methods according to an exemplary embodiment.

FIGS. 4A, 4B, and 4C are flowcharts illustrating methods according to an exemplary embodiment.

FIG. 5 is a flowchart illustrating a method according to an exemplary embodiment.

FIG. 6 is a diagram illustrating a neural network according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features, advantages, and characteristics of an embodiment. In other instances, additional features, advantages, and characteristics may be recognized in certain embodiments that may not be present in all embodiments. One skilled in the relevant art will recognize that any of the features, advantages, and characteristics of any embodiment can be interchangeably combined with the features, advantages, and characteristics of any other embodiment.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Conventional systems for handling fraud liability in online transactions pose significant challenges. In these systems, the burden of fraud liability typically falls on the merchants. This approach stems from the inability to control how customers handle their cards or how merchants store the card information. As a result, merchants often absorb the financial losses associated with fraudulent transactions. This not only creates financial strain for the merchants but also fails to address the root causes of fraud effectively and therefore does not promote fraud reduction or prevention.

However, systems and methods of the present disclosure offer a solution to this problem by introducing a novel approach to shifting fraud liability from merchants to banks. By leveraging data collection and machine learning, a bank or a central risk authority (e.g., a central processor and/or central processor application) can assume responsibility for fraud liability, thus alleviating the burden conventionally placed on the merchants. The key to this solution lies in the comprehensive collection of risk data throughout the customer's journey, from website entry to checkout. To implement the systems and methods of the present disclosure, a software development kit (SDK) is installed on the merchant's platform, allowing the bank via the central processor to collect essential risk signals and customer data. The collected data encompasses various aspects such as user behavior, internet protocol (IP) addresses, browser configurations, and Wi-Fi network information. This rich dataset enables the bank to conduct thorough risk assessments and make informed decisions regarding the level of risk associated with each transaction. The bank can accomplish these actions through machine learning and neural networks.

Furthermore, the banks have access to proprietary information, including transactional data and purchase patterns across multiple merchants. By analyzing this data, the bank or central authority can identify patterns and establish customer profiles. For instance, recurring purchases by a specific customer can serve as a strong risk-defining factor. This detailed profiling, coupled with the broader scope of data collected across merchants, enhances the banks' ability to make more confident risk determinations.

The shift in fraud liability not only benefits the merchants by reducing their financial burden but also incentivizes their active participation in providing risk data. With the ability to aggregate and analyze vast amounts of data, the banks become better risk managers, surpassing the capabilities of other payment providers. This, in turn, creates a compelling value proposition for merchants who prioritize liability shift and risk management.

In summary, the conventional system's problem of placing fraud liability on merchants is effectively addressed by the systems and methods of the present disclosure. By leveraging data collection, analysis, and profiling across multiple merchants, banks or central risk authorities can assume fraud liability, freeing the merchants from this financial burden. This innovative approach not only enhances risk assessment accuracy but also fosters collaboration between banks and merchants in combating fraudulent transactions.

The embodiments provide a number of technological improvements over conventional systems. By utilizing a specialized SDK and data collection mechanisms, the invention enables more comprehensive monitoring and analysis of user behavior, transactional data, and risk signals. This leads to improved fraud detection capabilities, allowing for timely identification of suspicious activities and potential fraudsters. Furthermore, the embodiments can rely on advanced processing capabilities like cloud computing to analyze large volumes of data collected from multiple sources. This may involve one or more efficient data handling techniques, including data compression, filtering, and extraction of relevant information. The processing power of the system is optimized to handle real-time risk calculations and make prompt decisions during the checkout process. Additionally, the invention incorporates measures to ensure the secure transmission and storage of sensitive data. This includes encryption protocols, secure network connections, and robust authentication mechanisms to safeguard the privacy and integrity of customer information. By bolstering network security, the invention helps protect against data breaches and unauthorized access attempts. Furthermore, the invention optimizes the utilization of memory resources by employing intelligent data storage techniques. It efficiently manages the storage and retrieval of risk-related data, allowing for quick access during risk assessments and decision-making processes. This helps streamline memory usage and ensures that relevant information is readily available for analysis.

Also, the embodiments facilitate seamless data integration across multiple merchants and banks, creating a collaborative environment for risk assessment and fraud prevention. It enables the exchange of standardized risk data between different entities, promoting interoperability and collective efforts in combating fraudulent activities.

Additionally, the embodiments may leverage sophisticated algorithms and machine learning techniques to identify patterns, anomalies, and risk factors in large datasets. By analyzing historical transactional data and user behaviors, the system can learn and adapt to evolving fraud patterns, improving its ability to detect and prevent fraudulent transactions effectively, as well as determine whether a shift in fraud responsibility from a merchant to a bank or account provider is warranted.

Overall, systems and methods of the present disclosure introduce technological improvements in terms of data processing, network security, memory optimization, and advanced algorithms. This empowers computer systems and networks with enhanced fraud detection capabilities, efficient data handling, and secure information exchange, thereby contributing to a more robust and intelligent system for managing online transaction risks.

In embodiments, system and methods of the present disclosure involve a partnership between multiple banks that install a browser extension alongside their banking applications. That is, when a user downloads a banking application (e.g. a mobile application), a browser extension is likewise downloaded to the user device. This extension is the same across all participating banks and serves as a means of communication with merchant websites. Thus, the browser extension acts in the same way regardless of which specific banking application is downloaded onto the user device. The primary purpose of this extension is to facilitate a secure and controlled authentication process for bank customers when making online purchases at partner merchant websites.

Generally, the browser extension is installed when a primary banking app is installed on the user's device (e.g. a smart device). Because multiple banks have already engaged in a partnership, each bank agrees to provide the same browser extension for each of their banking applications. The system includes a central authority (e.g. a central processor and/or a central processor application) that manages the communication and authentication process between the browser extension and the participating banks. The system uses public-private key cryptography to cryptographically confirm the validity of the browser extension, ensuring secure communication between the extension and the central authority. To enable smooth interactions with merchant websites, the extension uses Javascript remote procedure call (RPC) to communicate with the websites. A manifest.js file controlled by the bank determines which merchant websites can communicate with the extension. Crucially, merchants do not need to actively cooperate or integrate software development kits (SDKs) into their websites.

When a customer visits a partner merchant's website, the browser extension monitors the checkout flow. If the customer enters an email address, the extension reads and hashes it, then sends it to the central authority. If the email belongs to a customer of one of the banks, the extension triggers an authentication process, allowing the customer to choose their bank for checkout. Additionally, the browser extension serves as a central location to leverage biometrics, such as facial recognition or fingerprint recognition, for additional security during the authentication process. This feature is particularly relevant for iOS devices starting from version 16.1. In an alternative embodiment, the extension and merchant websites can exchange public-private key cryptography. The merchant issues a challenge to the extension, which signs the challenge to prove its identity. All banks need to agree on the cryptography used and ensure consistency across their installed browser extensions.

The systems and methods described herein offer several advantages over conventional checkout systems. The systems and methods allow multiple banks to collaborate and participate in a partnership to offer a unified and consistent authentication solution. This cross-bank collaboration ensures that customers of any participating bank can enjoy the same benefits when shopping at partner merchant websites. The browser extension installed by each bank remains persistent across all merchant websites. This persistence ensures that the authentication functionality is readily available for customers whenever they make a purchase at any partner merchant, without requiring repetitive installations or activations. Unlike traditional SDK integrations, the systems and methods eliminate the need for merchant cooperation and integration efforts. More specifically, merchants do not have to modify their websites via an SDK to accommodate the authentication process. Instead, the browser extension handles the communication with the merchant website through Javascript RPC, streamlining the integration process. Furthermore, the browser extension serves as a secure and centralized location for authentication. It communicates with a central authority used by all participating banks, which manages the authentication process. This centralized approach ensures consistency and security across all transactions.

The systems and methods employ public-private key cryptography to validate the authenticity of the browser extension. This cryptographic mechanism ensures that the extension is genuine and authorized by the participating banks. It prevents malicious or unauthorized extensions from interfering with the authentication process.

The browser extension leverages biometrics such as FaceID or TouchID, making use of the latest technology available on iOS devices. This adds an extra layer of security to the authentication process, making it convenient and robust for users. The browser extension maintains a persistent location for the authentication token, eliminating the need to drop a cookie. This token persistence ensures that users don't have to reauthenticate frequently, making the checkout process more user-friendly and efficient. The extension establishes a secure communication channel between the merchant website and the central authority. This secure channel ensures that sensitive information, such as the hashed email data, is transmitted safely and cannot be intercepted or tampered with during transmission. The system allows banks to remotely activate partner merchants only when they are under contract. This controlled activation ensures that the authentication process is limited to trusted partner merchants and reduces the risk of unauthorized access to the system. Overall, these technical improvements make the described system an innovative and effective solution for providing a secure, consistent, and user-friendly authentication and checkout process for customers across multiple banks and partner merchant websites.

The systems and methods do not require merchant websites to integrate SDKs, reducing the complexity of implementation. The extension provides a secure channel for authentication, controlled by the banks, ensuring a safe and reliable checkout process. The extension's presence across all merchant websites ensures a consistent user experience and authentication process.

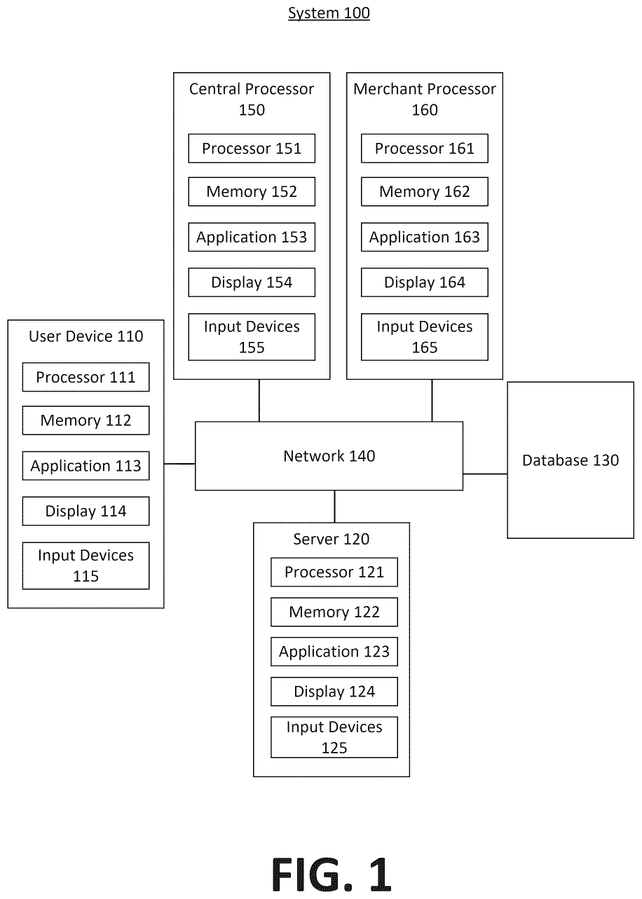

FIG. 1 illustrates a system 100 according to an exemplary embodiment. The system 100 may comprise a user device 110, a server 120, a database 130, a network 140, a central processor 150, and a merchant processor 160. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that, for example, enable network communications with one or more components of the system 100, transmit and/or receive data, and perform the functions described herein. Upon execution by the processor 111, the application 113 may perform the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The server 120 can be onsite, offsite, standalone, networked, online, or offline.

The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that, for example, enable network communications with one or more components of the system 100, transmit and/or receive data, and perform the functions described herein. Upon execution by the processor 121, the application 123 may perform the functions described in this specification, specifically to execute and perform the steps and functions in the process flows described below. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the server 120 that is available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include a database 130. The database 130 may be one or more databases configured to store data, including without limitation, private data of users, financial accounts of users, identities of users, transactions of users, and certified and uncertified documents. The database 130 may comprise a relational database, a non-relational database, or other database implementations, and any combination thereof, including a plurality of relational databases and non-relational databases. In some examples, the database 130 may comprise a desktop database, a mobile database, or an in-memory database. Further, the database 130 may be hosted internally by the server 120 or may be hosted externally of the server 120, such as by a server, by a cloud-based platform, or in any storage device that is in data communication with the server 120.

System 100 may include one or more networks 140. In some examples, the network 140 may be one or more of a wireless network, a wired network or any combination of wireless network and wired network, and may be configured to connect the user device 110, the server 120, and the database 130. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

The central processor 150 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The central processor 150 may include a processor 151, a memory 152, and an application 153. The processor 151 may be a processor, a microprocessor, or other processor, and the central processor 150 may include one or more of these processors.

The processor 151 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 151 may be coupled to the memory 152. The memory 152 may be a read-only memory, write-once read-multiple memory or read/write memory, e.g., RAM, ROM, and EEPROM, and the central processor 150 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 152 may be configured to store one or more software applications, such as the application 153, and other data, such as user's private data and financial account information.

The application 153 may comprise one or more software applications comprising instructions for execution on the central processor 150. In some examples, the central processor 150 may execute one or more applications, such as software applications, that, for example, enable network communications with one or more components of the system 100, transmit and/or receive data, and perform the functions described herein. Upon execution by the processor 151, the application 153 may perform the functions described in this specification, specifically to execute and perform the steps and functions in the process flows described below. Such processes may be implemented in software, such as software modules, for execution by computers or other machines. The application 153 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The central processor 150 may further include a display 154 and input devices 155. The display 154 may be any type of device for presenting visual information such as a computer monitor, a flat panel display, and a mobile device screen, including liquid crystal displays, light-emitting diode displays, plasma panels, and cathode ray tube displays. The input devices 155 may include any device for entering information into the central processor 150 that is available and supported by the central processor 150, such as a touch-screen, keyboard, mouse, cursor-control device, touch-screen, microphone, digital camera, video recorder or camcorder. These devices may be used to enter information and interact with the software and other devices described herein.

The merchant processor 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The merchant processor 160 may include a processor 161, a memory 162, and an application 163. The processor 161 may be a processor, a microprocessor, or other processor, and the merchant processor 160 may include one or more of these processors.

The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the merchant processor 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the merchant processor 160. In some examples, the merchant processor 160 may execute one or more applications, such as software applications, that, for example, enable network communications with one or more components of the system 100, transmit and/or receive data, and perform the functions described herein. Upon execution by the processor 161, the application 163 may perform the functions described in this specification, specifically to execute and perform the steps and functions in the process flows described below. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The merchant processor 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the merchant processor 160 that is available and supported by the merchant processor 160, such as a touch-screen, keyboard, mouse, cursor-control device, touch-screen, microphone, digital camera, video recorder or camcorder. These devices may be used to enter information and interact with the software and other devices described herein.

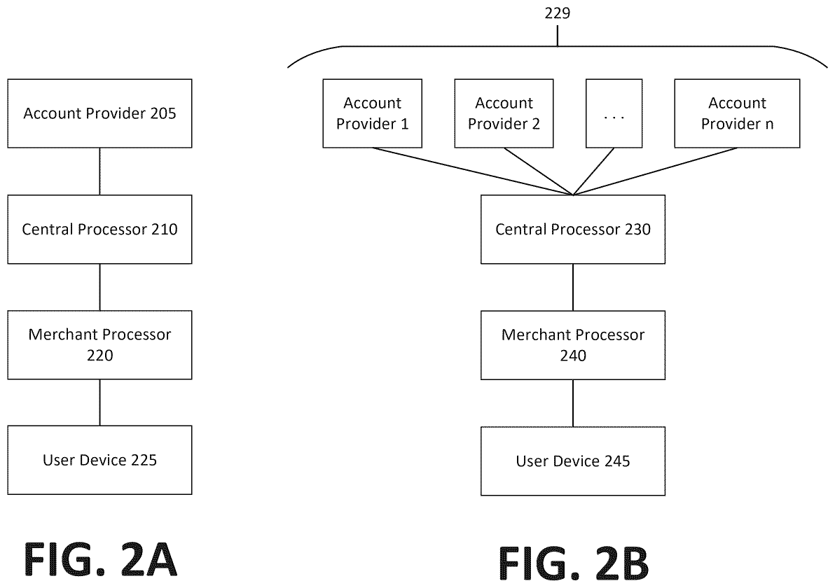

FIGS. 2A and 2B describe two embodiments of exemplary systems. In FIG. 2A, the central processor 210 is connected to a single account provider 205. An account provider can include a processor or server associated with a provider of personal financing and payment services, including without limitation checking accounts, savings accounts, credit accounts, or some combination thereof. For example, an account provider can include the credit card provider associated with a user's credit card. The central processor 210 can also be connected to a merchant processor 220 and a user device 225 over a network discussed with further reference to FIG. 1. The single account provider 205 can be associated with a bank or banking application including one or more transaction accounts such as a checking, savings, or growth accounts. Furthermore, the accounts can be associated with one or more transaction cards such as credit cards, charge cards, debit cards, gift cards, rewards cards, or some other transaction card. In this embodiment, the account provider 205 and the central processor 210 share information regarding the one or more transaction accounts associated with the account provider 205. In some embodiments, the central processor 210 may query the account provider 205 for each individual online transaction, e.g., the central processor 210 may make separate requests for payment credentials for each transaction. In other embodiments, the central processor 210 may have a relationship with the account provider 205 such that the payment credentials usually handled by the account provider 205 will be processed by the central processor 210 as well. That is, the central processor 210 already has the payment credentials, so the central processor 210 does not have to query the account provider 205 for every single transaction. This embodiment presumes that the central processor 210 and account provider 205 have already communicated with one another and have granted the central processor 210 the permission to have and use the payment credentials associated with one or more transaction accounts associated with the account provider 205.

In an exemplary embodiment, the user device 225 can be used to initiate an online consumer transaction associated with a particular merchant. The particular merchant can have a merchant processor 220 outfitted with an SDK including a collection of tools, libraries, documentation, and sample code meant to gather transaction profile information associated with the user and the present online consumer transaction and/or a browser extension 221. When the user device 225 initiates the online transaction, the merchant processor 220 can gather one or more information items about the transaction, including without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof.

In FIG. 2B, the central processor 230 can similarly be in communication with a merchant processor 240 and a user device 245 over one or more networks discussed with further reference to FIG. 1. In this embodiment, the central processor 230 can be associated with multiple account providers 229, for example Account Provider 1, Account Provider 2, . . . , up to Account Provider n. The account providers 229 can each be associated with a bank or banking application including one or more transaction accounts such as a checking, savings, or growth accounts. Furthermore, the accounts can be associated with one or more transaction cards such as credit cards, charge cards, debit cards, gift cards, rewards cards, or some other transaction card. In some embodiments, the central processor 210 may query the account providers 229 for each individual online transaction, e.g., the central processor 210 may make separate requests for payment credentials for each transaction. In other embodiments, the central processor 210 may have a relationship with the account providers 229 such that the payment credentials usually handled by the account providers 229 will be processed by the central processor 210 as well. That is, the central processor 210 already has the payment credentials, so the central processor 210 does not have to query the account providers 229 for every single transaction. This embodiment presumes that the central processor 210 and account providers 229 have already communicated with one another and have granted the central processor 210 the permission to have and use the payment credentials associated with one or more transaction accounts associated with the account providers 229.

In an exemplary embodiment, the user device 245 can be used to initiate an online consumer transaction associated with a particular merchant. The particular merchant can have a merchant processor 240 outfitted with an SDK including a collection of tools, libraries, documentation, and sample code meant to gather transaction profile information associated with the user and the present online consumer transaction and/or a browser extension 214. When the user device 245 initiates the online transaction, the merchant processor 240 can gather one or more information items about the transaction, including without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof.

The browser extensions 221 and 241 can be built using web technologies like HTML, cascading style sheets (CSS), and JavaScript, along with browser-specific extension APIs (Application Programming Interfaces). These APIs grant extensions access to certain browser functionalities and data. When installing an extension, the user is typically asked to grant the necessary permissions required for the extension to work properly. Extensions can listen for specific events, such as page loads or user actions, and trigger actions accordingly. This allows extensions to react to user interactions and perform tasks as needed. For example, the browser extension would be able to identify the cascading style sheets (CSS) and document object model (DOM) associated with the email entry field to kick off the flow. When an email is entered in the checkout flow, the extension would read it, hash it and send it to a central authority used by all the banks in the partnership. If the email is a customer of one of the banks then the extension would trigger and the customer would be offered an opportunity to checkout out using one of their banks. Browser extensions can store data locally to remember user preferences, settings, or activity history.

The browser extensions 221 and 241 can also use content scripts, which are JavaScript code injected into web pages. These scripts can read and manipulate the content of the page, including form fields like email input boxes. Extensions can register event listeners to capture user interactions. For example, an extension could listen for the “submit” event on the checkout form, intercepting the form data, including the email address, before it is sent to the server. Furthermore, the extensions can intercept and analyze network requests made by the browser. When the user submits the checkout form, the extension could intercept the HTTP request containing the email data and extract it before it is sent to the merchant's server.

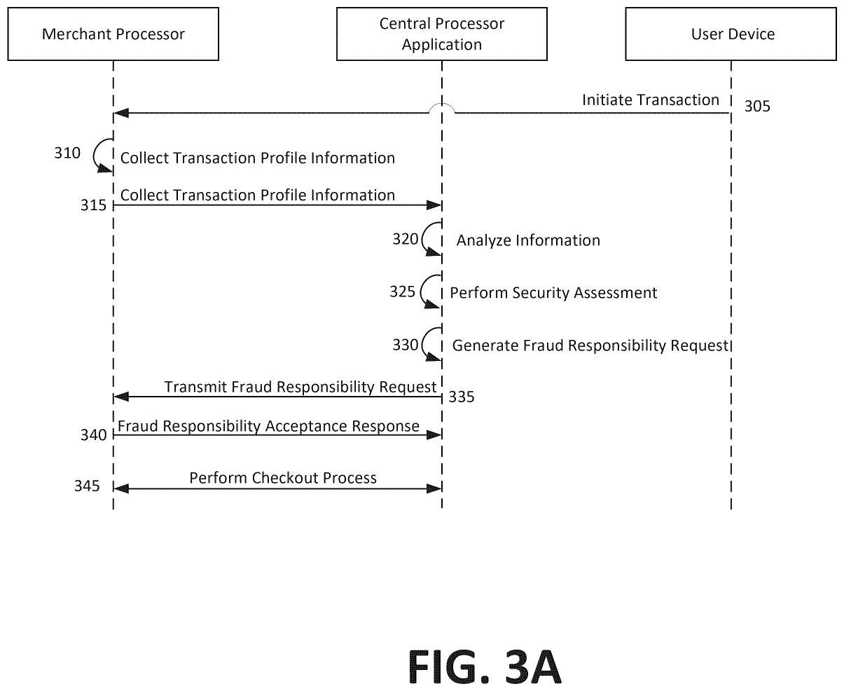

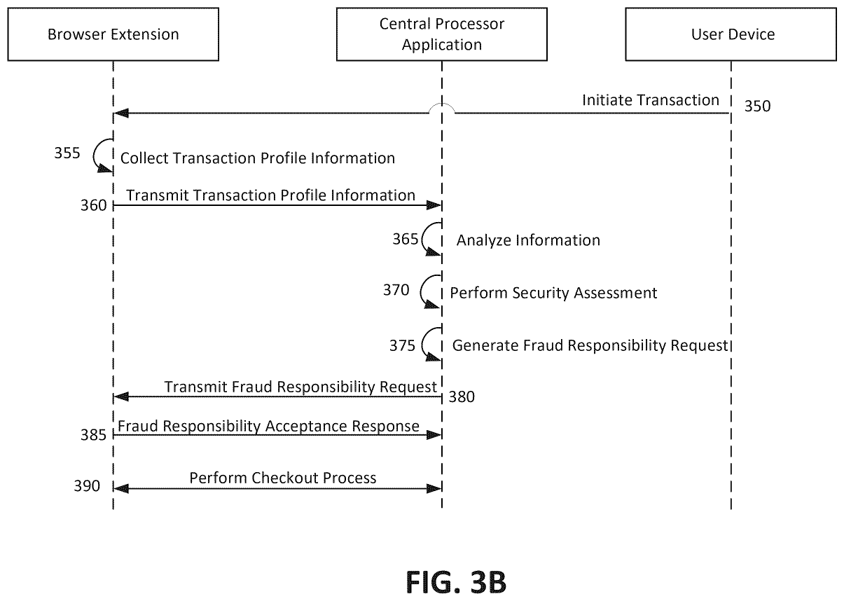

FIG. 3A illustrates a process for determining a security assessment of an online transaction and shifting fraud responsibility away from a merchant. The process can include without limitation a central processor application, a merchant processor, and a user device, each of which are discussed with further reference to FIG. 1 and FIGS. 2A-2B. In some embodiments, the user device can be used to initiate an online consumer transaction with a merchant. The merchant processor can be associated with the merchant, including without limitation a merchant website or a merchant application. The central processor application can be in communication with the merchant processor and use device over one or more networks. This central processor application can be software application configured to work with the user device. Furthermore, the merchant processor can be associated with a merchant website outfitted with an SDK configured to collect transaction profile information from a user via their user device.

In action 305, the user device can initiate an online transaction with the merchant processor. This action can include the user device inputting checkout information to the merchant processor, including without limitation name, username, address information, shipping information, and payment information. In action 310, the merchant processor can collect transaction profile information associated with the online transaction. The transaction profile information can include without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof. The transaction profile information can further include the checkout information provided by the user. The particular merchant processor can be outfitted with an SDK including a collection of tools, libraries, documentation, and sample code meant to gather transaction profile information associated with the user and the present online consumer transaction.

In action 315, the merchant processor can transmit the collected transaction profile information to the central processor. The merchant processor can share the information over a wired or wireless network. In other embodiments, the central processor application can request and retrieve the transaction profile information itself. Once the central processor application has received the transaction profile information, in action 320 the central processor application can analyze the transaction profile information.

In action 325, the central processor application can determine a security assessment of the transaction profile information. In making the security assessment, the central processor application can determine, based on the given transaction profile information, the likelihood of fraud associated with the present online transaction. The merchant processor can make this determination based on whether the transaction profile alone or in combination should be associated with fraudulent activity. For example, the merchant processor can determine that the IP address associated with the user device is far away from the user device's historical geolocation data. In other nonlimiting embodiments, the merchant processor can collect user behaviors associated with performing transactions including without limitation: spending history associated with the user and the merchant; purchase patterns; Wifi networks; browser configurations; and other user behaviors. For example, the merchant processor an identify the Wifi network associated with the user's device, then determine if the identified network matches the network historically used by the user device, most often used by the user, or a network that has ever been used by the user device. In still other embodiments, user behavior can include spending history associated with the merchant; repetition of purchases; how often purchases occurred with respect to the certain merchant; and general price range associated with the user's purchase history. In other embodiments, the merchant processor can compress the data present on the checkout page, which can be a highly entropic image, to identify a phone or computer graphical processing unit (GPU) and thus identify the user device associated with the transaction. The merchant processor can acquire one or more images from the target phone or computer. These images should have high entropy, containing complex patterns or seemingly random data, which will make the identification process more effective. The acquired images are then subjected to a compression process. Compression algorithms are used to reduce the size of the image files while attempting to retain as much essential information as possible. Different compression methods may be used, such as lossless or lossy compression. During the compression process, artifacts may be introduced into the images. Artifacts are distortions or irregularities that occur due to the compression algorithm. These artifacts can be unique to the specific compression process used by the GPU of the phone or computer. In order to identify the device, a reference database may be created. This database contains information about the compression artifacts generated by various GPUs on different phones and computers. Each entry in the database corresponds to a specific device-GPU combination. The compression artifacts in the compressed images are analyzed to extract specific features that are indicative of the GPU used for compression. These features may include patterns, noise, or other characteristics that are unique to the GPU's compression process. The extracted features are then compared to the reference database. The compression algorithm tries to find the best match between the features extracted from the compressed image and the entries in the reference database. If a close match is found, it indicates that the compressed image is likely processed by the GPU associated with that entry. Once a match is found in the reference database, the algorithm can infer the phone or computer's make and model, as well as the specific GPU used for compression.

Having reviewed the transaction profile information, the central processor application can grade the online transaction on a scale of low risk, medium risk, and high risk. In other embodiments, the central processor application may only grade for low risk or high risk. In still other embodiments, the central processor application may generate a numerical score or letter grade each with discrete value. In still other embodiments, the central processor application can generate a slidable scale of riskiness associated with the online transaction.

Having made the security assessment, the central processor application in action 330 can generate a fraud responsibility request. Generally, the fraud responsibility request is a request to make the one or more account providers associated with the central processor application responsible for refunding or repaying the customer in the event that the online transaction is fraudulent. The fraud responsibility request can be represented as a data structure or message in a standardized format, such as JSON (JavaScript Object Notation) or XML (eXtensible Markup Language). This message would typically contain relevant information about the transaction, such as transaction ID, transaction amount, merchant identification, customer information, and any additional data that might help in fraud evaluation. In some embodiments, there may be only one account provider, bank, banking application, or banking authority. In such embodiments, the merchant processor can communicate directly with the account provider which can analyze information, perform the security assessment, generate the fraud responsibility request, receive a response, and perform checkout. In other embodiments where several banks or account providers are present, the central processor application may act as a central authority through which the fraud responsibility request is generated and transmitted. In action 335, the central processor application can transmit the fraud responsibility request to the merchant processor. The fraud responsibility request message needs to be transmitted securely from the central processor application to the merchant processor to avoid interception or tampering. This transmission can be accomplished over a network using secure communication protocols, such as HTTPS (Hypertext Transfer Protocol Secure) or TLS (Transport Layer Security). To achieve secure communication, the central processor application and the merchant processor would have established a secure connection using authentication methods like mutual TLS certificates or API keys. Once the secure connection is established, the fraud responsibility request message would be sent over this encrypted channel to the merchant processor. In action 340, the merchant processor can transmit a fraud responsibility acceptance response over the secure network. If the merchant processor accepts the fraud responsibility request, the central processor application and merchant processor can perform the checkout process in action 345. This action can involve the central processor application providing payment credentials to the merchant processor, and the merchant processor using the supplied payment credentials to complete the transaction.

FIG. 3B illustrates a process for determining a security assessment of an online transaction and shifting fraud responsibility away from a merchant. The process can include without limitation a central processor application, a browser extension, and a user device, each of which are discussed with further reference to FIG. 1 and FIGS. 2A-2B. In some embodiments, the user device can be used to initiate an online consumer transaction with a merchant. The browser extension can be associated with the merchant, including without limitation a merchant website or a merchant application. The central processor application can be in communication with the merchant processor and use device over one or more networks. This central processor application can be software application configured to work with the user device. Furthermore, the browser extension can be associated with a merchant website and be configured to collect transaction profile information from a user via their user device.

In action 350, the user device can initiate an online transaction on the merchant website or merchant application outfitted with the browser extension. This action can include the user device inputting checkout information on the website or checkout page, including without limitation name, username, address information, shipping information, and payment information. In action 355, the browser extension can collect transaction profile information associated with the online transaction. The transaction profile information can include without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof. The transaction profile information can further include the checkout information provided by the user.

In action 360, the browser extension can transmit the collected transaction profile information to the central processor. The browser extension can share the information over a wired or wireless network. In other embodiments, the central processor can request and retrieve the transaction profile information itself. Once the central processor has received the transaction profile information, in action 365 the central processor can analyze the transaction profile information.

In some embodiments, when an email or other personal information is entered into the merchant website, the browser extension will read the information, encrypt it, then transmit it to the central processor application. The central processor application can determine whether the email is on file with one or more account providers. If the email matches an email on file, then the central processor application can transmit the user a prompt to complete the checkout page using a payment method associated with one or more account providers. The user can select via the user device which payment method (e.g. which credit card) they would like to complete the transaction with, at which point the extension can fill the data fields on the website with the payment information.

In action 370, the central processor application can determine a security assessment of the transaction profile information. In making the security assessment, the central processor can determine, based on the given transaction profile information, the likelihood of fraud associated with the present online transaction. The central processor application can make this determination based on whether the transaction profile alone or in combination should be associated with fraudulent activity. For example, the browser extension can determine that the IP address associated with the user device is far away from the user device's historical geolocation data. In other nonlimiting embodiments, the browser extension can collect user behaviors associated with performing transactions including without limitation: spending history associated with the user and the merchant; purchase patterns; Wifi networks; browser configurations; and other user behaviors. For example, the browser extension an identify the Wifi network associated with the user's device, then determine if the identified network matches the network historically used by the user device, most often used by the user, or a network that has ever been used by the user device. In still other embodiments, user behavior can include spending history associated with the merchant; repetition of purchases; how often purchases occurred with respect to the certain merchant; and general price range associated with the user's purchase history. In other embodiments, the browser extension can compress the data present on the checkout page, which can be a highly entropic image, to identify a phone or computer graphical processing unit (GPU) and thus identify the user device associated with the transaction. The browser extension can acquire one or more images from the target phone or computer. These images should have high entropy, containing complex patterns or seemingly random data, which will make the identification process more effective. The acquired images are then subjected to a compression process. Compression algorithms are used to reduce the size of the image files while attempting to retain as much essential information as possible. Different compression methods may be used, such as lossless or lossy compression. During the compression process, artifacts may be introduced into the images. Artifacts are distortions or irregularities that occur due to the compression algorithm. These artifacts can be unique to the specific compression process used by the GPU of the phone or computer. In order to identify the device, a reference database may be created. This database contains information about the compression artifacts generated by various GPUs on different phones and computers. Each entry in the database corresponds to a specific device-GPU combination. The compression artifacts in the compressed images are analyzed to extract specific features that are indicative of the GPU used for compression. These features may include patterns, noise, or other characteristics that are unique to the GPU's compression process. The extracted features are then compared to the reference database. The compression algorithm tries to find the best match between the features extracted from the compressed image and the entries in the reference database. If a close match is found, it indicates that the compressed image is likely processed by the GPU associated with that entry. Once a match is found in the reference database, the algorithm can infer the phone or computer's make and model, as well as the specific GPU used for compression.

Having reviewed the transaction profile information, the central processor application can grade the online transaction on a scale of low risk, medium risk, and high risk. In other embodiments, the central processor application may only grade for low risk or high risk. In still other embodiments, the central processor application generate a numerical score or letter grade each with discrete value. In still other embodiments, the central processor application can generate a slidable scale of riskiness associated with the online transaction.

Having made the security assessment, the central processor application in action 375 can generate a fraud responsibility request. Generally, the fraud responsibility request is a request to make the one or more account providers associated with the central processor responsible for refunding or repaying the customer in the event that the online transaction is fraudulent. The fraud responsibility request can be represented as a data structure or message in a standardized format, such as JSON (JavaScript Object Notation) or XML (eXtensible Markup Language). This message would typically contain relevant information about the transaction, such as transaction ID, transaction amount, merchant identification, customer information, and any additional data that might help in fraud evaluation. In some embodiments, there may be only one account provider, bank, banking application, or banking authority. In such embodiments, the browser extension can communicate directly with the account provider which can analyze information, perform the security assessment, generate the fraud responsibility request, receive a response, and perform checkout. In other embodiments where several banks or account providers are present, the central processor application may act as a central authority through which the fraud responsibility request is generated and transmitted. In action 380, the central processor application can transmit the fraud responsibility request to the browser extension, which in turn can communicate the request with the merchant processor. The fraud responsibility request message needs to be transmitted securely from the central processor application to the merchant processor to avoid interception or tampering. This transmission can be accomplished over a network using secure communication protocols, such as HTTPS (Hypertext Transfer Protocol Secure) or TLS (Transport Layer Security). To achieve secure communication, the central processor application and the merchant processor would have established a secure connection using authentication methods like mutual TLS certificates or API keys. Once the secure connection is established, the fraud responsibility request message would be sent over this encrypted channel to the merchant processor. In action 385, the merchant processor can transmit a fraud responsibility acceptance response over the secure network. If the merchant processor accepts the fraud responsibility request, the central processor application and merchant processor can perform the checkout process in action 390. This action can involve the central processor application providing payment credentials to the browser extension, which in turns shares the credentials with the merchant processor, and the merchant processor using the supplied payment credentials to complete the transaction.

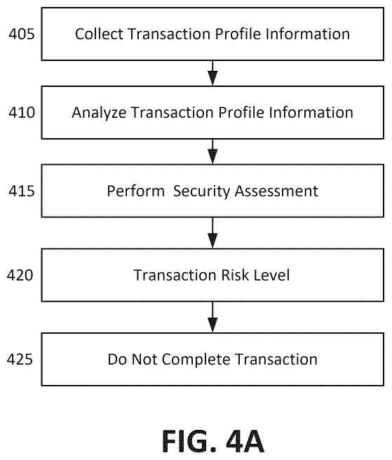

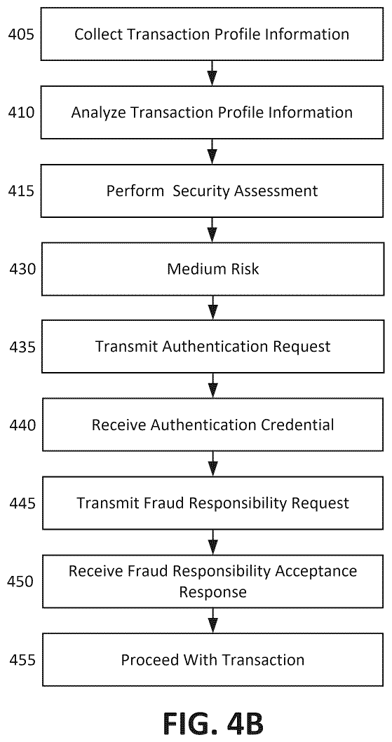

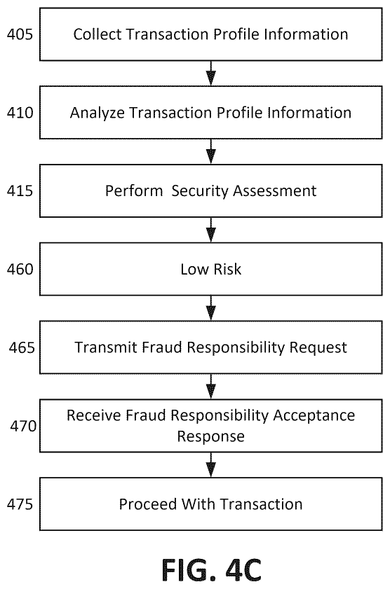

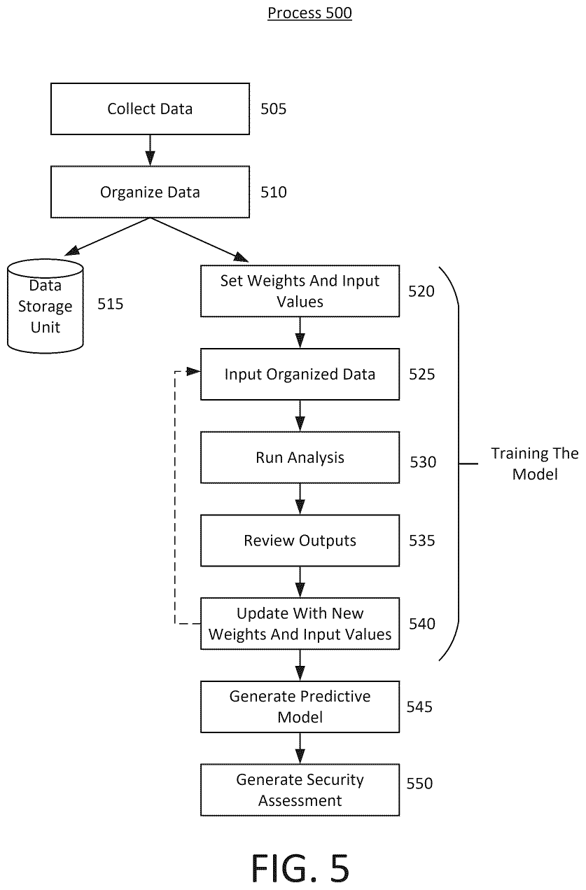

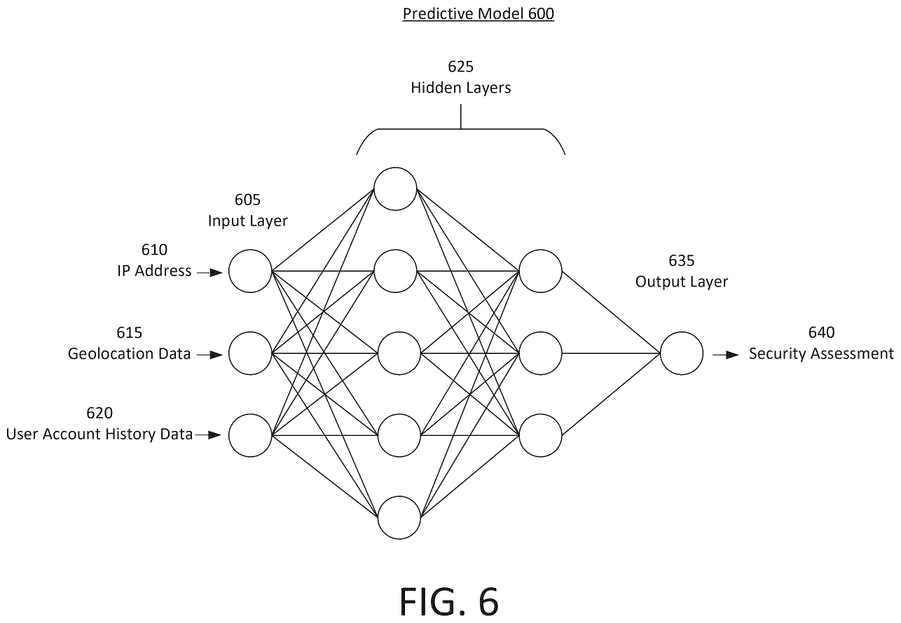

FIGS. 4A, 4B, and 4C illustrate a process in which the central processor application can determine a security assessment, then based on the assessment perform different actions related to the outcome of the security assessment. FIG. 4A illustrates a high risk scenario. FIG. 4B illustrates a medium risk scenario. FIG. 4C illustrates a low risk scenario. The central processor application can utilize one or more machine learning or trained models such as neural networks and algorithms to analyze the transaction profile information and ultimately perform the security assessment. The training and utilization of such models is discussed with further reference to FIGS. 5-6. In some embodiments, the there may be only one account provider, bank, banking application, or banking authority associated with user. That is, the user may only have one account or one payment card. In such embodiments, the merchant processor and/or browser extension can communicate directly with the account provider which can analyze information, preform the security assessment, generate the fraud responsibility request, receive a response, and perform checkout. In other embodiments where several banks or account providers are present, the central processor application may act as a central authority through which the fraud responsibility request is generated and transmitted.

This process assumes that a user device is attempting to complete an online transaction with a merchant, e.g., a merchant website. Referring to FIG. 4A, in action 405 the central processor application can collect transaction profile information. The transaction profile information can include without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof. The transaction profile information can further include the checkout information provided by the user. The particular merchant processor, merchant application, or merchant website can be outfitted with an SDK including a collection of tools, libraries, documentation, and sample code meant to gather transaction profile information associated with the user and the present online consumer transaction to the central processor application and/or a browser extension configured to collect and transmit this data to the central processor application. Once the central processor application has received the transaction profile information from the merchant processor, in action 410 the central processor application can analyze the transaction profile information.

In action 415, the central processor application can determine a security assessment of the transaction profile information. In making the security assessment, the central processor application can determine, based on the given transaction profile information, the likelihood of fraud associated with the present online transaction. The central processor application can make this determination based on whether the transaction profile alone or in combination should be associated with fraudulent activity. For example, the central processor application can determine that the IP address associated with the user device deviates from the user device's historical geolocation data. Having reviewed the transaction profile information, the central processor application can grade the online transaction on a scale of low risk, medium risk, and high risk. Although FIGS. 4A-4C only show these three pathways, in other embodiments the central processor application can make other determinations. As a nonlimiting example, the central processor application may only grade for low risk or high risk. In still other embodiments, the central processor generate a numerical score or letter grade each with discrete values.

The central processor application can determine based on the security assessment the online transaction risk level, e.g., that the online transaction is high risk 420, medium risk 430, or low risk 460. These determinations can be made based on predetermined or learned associations with certain transaction profile information. For example, the central processor application can have a rule that any time a user's IP address deviates from the user device's historical geolocation data, the security assessment must result in at least a medium risk assessment or higher. Upon determining that the online transaction is high risk in action 420, in action 425 the central processor application can elect to not provide the payment credentials necessary to complete the transaction. In other embodiments, the central processor application can simply elect to not shift any fraud responsibility from the merchant to the central processor. In still other embodiments, the central processor application can request multiple authentication credentials before subsequently requesting to shift fraud responsibility. Furthermore, the central processor application can require other payment methods to be provided before proceeding with transmitting a fraud responsibility request. For example, the central processor application may require the user to provide credentials regarding a second or otherwise separate payment method such as another credit card, debit card, or payment account. In still other embodiments, the user may also be asked to use a debit card or cash transfer application linked to a checking account. For example, the user may receive a prompt to authenticate themselves in a separate linked user application such as a credit card application. Once the user verifies themselves separately on the user application, the user may proceed with making the transaction, and the central processor application may transmit a fraud responsibility request to the merchant processor.

Referring to FIG. 4B, upon determining that there is medium risk in action 430 the central processor application in action 435 can transmit an authentication request to the user device associated with the online transaction. In action 440, the central processor application can receive an authentication credential. Having verified the user device, the central processor application in action 445 can transmit a fraud responsibility request to the merchant processor, and in action 450 the central processor application can receive a fraud responsibility acceptance response from the merchant processor. Having shifted responsibility, the central processor application in action 455 can proceed with facilitating the completion of the online transaction. This action can involve the central processor application providing payment credentials to the merchant processor, and the merchant processor using the supplied payment credentials to complete the transaction.

Referring to FIG. 4C, upon determining that there is low risk in action 460 the central processor application can proceed with shifting fraud responsibility without the need for requesting any authentication credentials. The low risk determination can result from various circumstances. As a nonlimiting example, the central processor application can determine that IP address and purchasing history closely aligns with historical information associated with the user and user device. In other embodiments, the central processor application can determine that the user has recently authenticated themselves on the same user device being used to complete the online transaction. In still other embodiments, the central processor application can determine that the online transaction is a repeat purchase. Having determined that the online transaction is low risk, in action 465 the central processor application can transmit a fraud responsibility request, and in action 470 the central processor application can receive a fraud responsibility acceptance response from the merchant processor. Finally, in action 475 can proceed with facilitating the completion of the online transaction. This action can involve the central processor application providing payment credentials to the merchant processor, and the merchant processor using the supplied payment credentials to complete the transaction. In some embodiments, different account providers may have different requirements for what qualifies as “low risk,” and the central processor may take these considerations into account.

In other embodiments, the central processor application can require the user to perform a manual input of data before either allowing the transaction to occur or before a fraud responsibility request is transmitted. For example, the central processor application may, upon determining that that there is a medium or high risk of fraud, block autofill tools by the browser. Thus, central processor application requires the user must enter their personal identifiable information (PII) data and payment data manually. In some instances, a fraud responsibility shift is not granted and merchants still assume liability for fraud. In another exemplary embodiment, the user can be recognized via an authentication credential and is allowed to use autofill tools to complete their PII and payment data. Consequently, a fraud responsibility shift is granted and the account provider assumes liability.

FIG. 5 is a flowchart illustrating the generation of a predictive model and the generating of a security assessment. The process 500 describes the training process for an exemplary predictive model or neural network suitable for the predicting and generating of one or more security assessments including at least a grade of whether an online transaction is high risk, medium risk, low risk, requires manual entry of data, or otherwise requires an authentication credential or manual data entry based on transaction profile information. The process can begin with action 505 when data, including transaction profile information, is collected. The raw data can be associated with the user device and the online transaction itself. The information can further include IP address; browser configuration; network details; stock keeping unit (SKU) data associated with the online transaction; search activities; product page views; typing patterns; typing speeds; geolocation data; time and date data; user account history data; device information; referral source; and any combination thereof.

The collection of raw data can be performed by an SDK and/or a browser extension associated with the merchant processor, which itself can be associated with a merchant website or merchant application. The raw data can be directly observed and retrieved by the SDK and/or browser extension, and other raw data can be transmitted over a wired or wireless network from the user device to the merchant processor. Once the data has been collected by the SDK and/or browser extension, the merchant processor can transmit the data to the central processor application. The data may have been previously gathered and stored in a database or data storage unit in which case the central processor application can retrieve the data from the data storage unit. The data can be received continuously or in batches. The raw data can be updated at any time. At action 510, the central processor application can organize the raw data into discernable categories including but not limited to location data, transaction data, and user device data. The categories can be predetermined by the user or created by the predictive model. At action 815, the organized data can be transmitted to the data storage unit. The data storage unit can be associated with the central processor application, central processor, or server including a cloud server. The raw or organized data can be transmitted over a wired network, wireless network, or one or more express buses. Upon organizing the data into one or categories, the central processor application can proceed with training the predictive model in actions 820 through 840. The training portion can have any number of iterations. The predictive model can comprise one or more neural networks described with further reference to FIG. 6.

The training portion can begin with action 520 when the weights and input values are set by the user or by the model itself. Furthermore, the weights can be the predetermined connections between the inputs and the hidden layers described with further reference to FIG. 6. The input values are the values that are fed into the neural network or predictive model. The input values may be discerned by the different categories created in action 510, although other distinct input values may be discerned. The inputs can include without limitation historical information related to the user's past transactions, other third party data about signs of fraud, and the user device. In action 525, the data in inputted in the neural network, and in action 530 the neural network analyzes the data according to the weights and other parameters set by the user. As a nonlimiting, example, the central processor may create the stipulation that any transaction with more than 10 items being purchased must be assessed as at least medium risk and up to high risk. In action 535, the outputs are reviewed. The outputs can include one or more security assessments varying from high risk, medium risk, to low risk. In other embodiments, the central processor application may only grade for low risk or high risk. In still other embodiments, the central processor application may generate a numerical score or letter grade each with discrete value. In still other embodiments, the central processor application can generate a slidable scale of riskiness associated with the online transaction.

In action 540, the predictive model may be updated with new data and parameters. The new data can be collected by the processor in a similar fashion to actions 505 and 510. Though it is not necessary in this exemplary embodiment to retrain the predictive model, the predictive model can be re-trained any number times such that actions 525 through 540 are repeated until a satisfactory output is achieved or some other parameter has been met. As a nonlimiting example, the central processor application may update the inputs with new transaction profile data. As another nonlimiting example, the central processor application can adjust the weighted relationship between the input layer and the one or more hidden layers of a neural network discussed with further reference to FIG. 6. If a satisfactory output has been recorded, then in action 545 one or more predictive models can be generated. It is understood that the predictive model, once generated, can undergo further training like actions 520 to 545. Having generated the predictive model, in action 550 the model can generate one or more security assessments given the unique input values collected from a particular online transaction and its associated user device.

FIG. 6 is a diagram illustrating a neural network as an exemplary embodiment for the predictive model. A neural network is a series of algorithms that can, under predetermined training restrictions, recognize relationships between one or more variables. A neuron in a neural network is a mathematical function that collects and classifies information according to a specific form set by a user. A neural network can be divided into three main components: an input layer, a processing or hidden layer, and an output layer. The input layer comprises data sets chosen to be inserted into the neural network for analysis. The hidden layers include one or more neurons that can classify the inputs according to parameters set by the user. The hidden layers can comprise multiple successive layers, the first layer positioned immediately after the input layer and the last layer positioned immediately before the output layer. The hidden layer immediately after the input layer may be connected to the input layer via a predetermined weight or emphasis. These weights can be assigned according to the modeler's agenda. Alternatively, the model itself can determine the optimal weights between layers such that a predetermined outcome, margin of error, or minimum data point is achieved.

The predictive model can comprise a neural network 600. The neural network may be integrated into the central processor, the central processor application, the user device, the server, or some other computer device suitable for neural network analysis. In some embodiments, the central processor application can generate and run the neural network 600. The neural network can include an input layer 605, one or more hidden layers 625, and an output layer 635. Although only a certain number of nodes are depicted in FIG. 6, it is understood that the neural network according to the disclosed embodiments may include less or more nodes in each layer. Additionally, the hidden layers can include more or less layers than what is depicted in FIG. 6. It is also understood that the connections between each layer may be assigned a predetermined weight according to the central processor application's manual change or according to some weight value generated by the neural network itself. The input layer may include sets of data gathered from outside sources. The neural network can include an IP address 610, geolocation data 615, and user account history data 620 that is interacting with the card. Other inputs not depicted in FIG. 6 can include: browser configuration; network details; stock keeping unit (SKU) data associated with the online transaction; search activities; product page views; typing patterns; typing speeds; time and date data; device information; and referral source. Upon analyzing the inputs via the one or more hidden layers, the neural network can create one or more security assessments 640. It is understood that one or more neural networks or some combination of neural networks can be trained according to individual users. It is understood that any of the neural networks described herein may be trained or iterated any number of times. In some embodiments, the neural network can be re-trained and/or updated after every recordation of new online consumer transaction. In still other embodiments, the neural network can be trained until a sufficient level of accuracy has been reached. Furthermore, the neural networks can be trained to arrive at any number of conclusions, including how much risk (quantified as a currency) the central processor should take on, and how many authentication credentials the central processor should request from the user device.

In some embodiments, the application can analyze document information using a predictive model including without limitation a recursive neural network (RNN), convolutional neural network (CNN), artificial neural network (ANN), or some other neural network. The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as CNNs or RNNs, to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

In some aspects, the techniques described herein relate to a system including: a central processor application configured to: collect, from a merchant processor, transaction profile information associated with an online transaction; analyze the transaction profile information; determine, based on the analysis of the transaction profile information, a security assessment of the online transaction, wherein the security assessment indicates a measure of security associated with the online transaction; generate a fraud responsibility transfer request; transmit the fraud responsibility transfer request to the merchant processor; receive, from the merchant processor, an acceptance response including an agreement to transfer a fraud responsibility to the central processor application; and perform, based on the acceptance response, a checkout process for the online transaction, wherein the merchant processor shifts the fraud responsibility to the central processor application.

In some aspects, the techniques described herein relate to a system including: a central processor application configured to: collect, from a browser extension associated with a merchant website, transaction profile information associated with an online transaction; analyze the transaction profile information; determine, based on the analysis of the transaction profile information, a security assessment of the online transaction, wherein the security assessment indicates a measure of security associated with the online transaction; generate a fraud responsibility transfer request; transmit the fraud responsibility transfer request to the merchant processor; receive, from the browser extension, an acceptance response including an agreement to transfer a fraud responsibility to the central processor application; and perform, based on the acceptance response, a checkout process for the online transaction, wherein the browser extension shifts the fraud responsibility to the central processor application.

In some aspects, the techniques described herein relate to a system, wherein the merchant processor includes a software development kit (SDK) configure to collect from the merchant processor the transaction profile information.

In some aspects, the techniques described herein relate to a system, wherein the browser extension is configured to identify the cascading style sheets (CSS) and document object model (DOM) associated with an email entry field on the merchant website.

In some aspects, the techniques described herein relate to a system, wherein the transaction profile information includes at least an internet protocol (IP) address, a browser configuration, and one or more network details.

In some aspects, the techniques described herein relate to a system, wherein said transaction profile information includes one or more stock keeping unit (SKU) data associated with the online transaction.

In some aspects, the techniques described herein relate to a system, wherein said transaction profile information includes one or more search activities and product page views associated with the merchant processor.

In some aspects, the techniques described herein relate to a system, wherein the security assessment includes one or more security levels, including a high-risk level, a medium-risk level, and a low-risk level.

In some aspects, the techniques described herein relate to a system, wherein the central processor application, upon determining the medium-risk level, is further configured to: transmit, to a user device associated with the online transaction, an authentication request; and receive, from the user device, a user authentication credential.

In some aspects, the techniques described herein relate to a system, wherein the central processor application, upon determining the security assessment, transmits one or more fraud alerts to the merchant processor.

In some aspects, the techniques described herein relate to a system, wherein the transaction profile information includes geolocation data of a user device associated with the online transaction.

In some aspects, the techniques described herein relate to a system, wherein the analysis of the transaction profile information includes a machine learning algorithm configured to determine the security assessment based at least on the transaction profile information.

In some aspects, the techniques described herein relate to a method including: collecting, by a central processor application from a merchant processor, transaction profile information associated with an online transaction; analyzing, by the central processor application, the transaction profile information; determining, by the central processor application based on the analysis of the transaction profile information, a security assessment of the online transaction, wherein the security assessment indicates a measure of security associated with the online transaction; generating, by the central processor application, a fraud responsibility transfer request; transmitting the fraud responsibility transfer request to the merchant processor; receiving, from the merchant processor, an acceptance response including an agreement to transfer a fraud responsibility to the central processor; and performing, based on the acceptance response, a checkout process for the online transaction, wherein the merchant processor shifts the fraud responsibility to the central processor application.

In some aspects, the techniques described herein relate to a method including: collecting, by a central processor application from a browser extension associated with a merchant website, transaction profile information associated with an online transaction; analyzing, by the central processor application, the transaction profile information; determining, by the central processor application based on the analysis of the transaction profile information, a security assessment of the online transaction, wherein the security assessment indicates a measure of security associated with the online transaction; generating, by the central processor application, a fraud responsibility transfer request; transmitting the fraud responsibility transfer request to the browser extension; receiving, from the browser extension, an acceptance response including an agreement to transfer a fraud responsibility to the central processor; and performing, based on the acceptance response, a checkout process for the online transaction, wherein the browser extension shifts the fraud responsibility to the central processor application.

In some aspects, the techniques described herein relate to a method, wherein the security assessment includes one or more security levels, including a high-risk level and a low-risk level.

In some aspects, the techniques described herein relate to a method, wherein upon determining the high-risk level the central processor application rejects the online transaction.

In some aspects, the techniques described herein relate to a method, wherein upon determining the low-risk level the central processor application requests the merchant processor to perform an expedited checkout process.

In some aspects, the techniques described herein relate to a method, wherein upon determining a high-risk level the central processor application requests the merchant processor to provide one or more additional transaction details associated with the online transaction.

In some aspects, the techniques described herein relate to a method, wherein upon determining a high-risk level the method further includes: transmitting, to a user device associated with the online transaction, an authentication request; and receiving, from the user device, a user authentication credential.

In some aspects, the techniques described herein relate to a method, wherein the central processor application is associated with one account provider.

In some aspects, the techniques described herein relate to a method, wherein the central processor application is associated with a plurality of account providers, wherein each account provider includes at least one transaction account associated with a user associated with the online transaction.

In some aspects, the techniques described herein relate to a method, wherein transaction profile information includes one or more typing patterns or typing speeds.

In some aspects, the techniques described herein relate to a method, wherein the transaction profile information includes a type of user device being used to complete the transaction.

In some aspects, the techniques described herein relate to a non-transitory computer readable medium containing computer executable instructions that, when executed by a device comprising a processor, cause the device to perform procedures including: collecting, from a merchant processor, transaction profile information associated with an online transaction; analyzing the transaction profile information; determining, based on the analysis of the transaction profile information, a security assessment of the online transaction, wherein the security assessment indicates a measure of security associated with the online transaction; generating a fraud responsibility transfer request; transmitting the fraud responsibility transfer request to the merchant processor; receiving, from the merchant processor, an acceptance response including an agreement to transfer a fraud responsibility; performing, based on the acceptance response, a checkout process for the online transaction, wherein the merchant processor shifts the fraud responsibility to the central processor application.

In some aspects, the techniques described herein relate to a non-transitory computer readable medium containing computer executable instructions that, when executed by a device including a processor, configure the processor to perform procedures including: collecting, from a browser extension associated with a merchant website, transaction profile information associated with an online transaction; analyzing the transaction profile information; determining, based on the analysis of the transaction profile information, a security assessment of the online transaction, wherein the security assessment indicates a measure of security associated with the online transaction; generating a fraud responsibility transfer request; transmitting the fraud responsibility transfer request to the browser extension; receiving, from the browser extension, an acceptance response including an agreement to transfer a fraud responsibility; and performing, based on the acceptance response, a checkout process for the online transaction, wherein the browser extension shifts the fraud responsibility from the merchant to an account provider.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Computer hardware may include the essential components necessary for a computer to run and perform software applications. These components consist of the Central Processing Unit (CPU), which acts as the computer's brain and executes instructions and calculations. Additionally, Random Access Memory (RAM) provides short-term memory, storing data temporarily while the CPU processes it. The computer's data is stored more permanently on Hard Disk Drives (HDD) or faster Solid State Drives (SSD). The motherboard serves as the main circuit board, connecting all components together, while the Graphics Processing Unit (GPU) renders images and videos, crucial for graphic-intensive tasks. A Power Supply Unit (PSU) converts electrical power for the computer, and cooling systems prevent overheating through fans and heat sinks. Input devices like keyboards and mice allow users to interact, while monitors serve as output devices. The Network Interface Card (NIC) enables network connectivity, and the Operating System (OS) manages hardware resources and facilitates user interaction. Peripheral devices, such as printers and webcams, can also be part of the computer hardware setup, expanding its functionality further. Implementations may be implemented as a computer program product, e.g., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

Throughout the disclosure, the term “bank” is used, and it is understood that the present disclosure is not limited to a particular bank or financial institution or type of bank or type of financial institution. Rather, the present disclosure includes any type of bank, financial institution, or other business involved in activities where products or services are sold or otherwise provided.

Throughout the disclosure, the term “card” is used, and it is understood that the present disclosure is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

Throughout the disclosure, the term “merchant” is used, and it is understood that the present disclosure is not limited to a particular merchant or type of merchant. Rather, it is understood that the present disclosure includes any type of merchant, vendor, or other entity involved in activities where products or services are sold or otherwise provided.

Throughout the disclosure, the term “account” is used, and it is understood that the present disclosure is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (e.g., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system comprising:
a central processor application configured to:
collect, from a merchant processor, transaction profile information associated with an online transaction;
analyze the transaction profile information;
determine, based on the analysis of the transaction profile information, a security assessment of the online transaction, wherein the security assessment indicates a measure of security associated with the online transaction;
generate a fraud responsibility transfer request;
transmit the fraud responsibility transfer request to the merchant processor;
receive, from the merchant processor, an acceptance response comprising an agreement to transfer a fraud responsibility to the central processor application; and
perform, based on the acceptance response, a checkout process for the online transaction, wherein the merchant processor shifts the fraud responsibility to the central processor application.

2. The system of claim 1, wherein the merchant processor comprises a software development kit (SDK) configure to collect from the merchant processor the transaction profile information.

3. The system of claim 1, wherein the transaction profile information comprises at least an internet protocol (IP) address, a browser configuration, and one or more network details.

4. The system of claim 1, wherein said transaction profile information comprises one or more stock keeping unit (SKU) data associated with the online transaction.

5. The system of claim 1, wherein said transaction profile information comprises one or more search activities and product page views associated with the merchant processor.

6. The system of claim 1, wherein the security assessment comprises one or more security levels, comprising a high-risk level, a medium-risk level, and a low-risk level.

7. The system of claim 6, wherein the central processor application, upon determining the medium-risk level, is further configured to:
transmit, to a user device associated with the online transaction, an authentication request; and
receive, from the user device, a user authentication credential.

8. The system of claim 1, wherein the central processor application, upon determining the security assessment, transmits one or more fraud alerts to the merchant processor.

9. The system of claim 1, wherein the transaction profile information comprises geolocation data of a user device associated with the online transaction.

10. The system of claim 1, wherein the analysis of the transaction profile information comprises a machine learning algorithm configured to determine the security assessment based at least on the transaction profile information.

11. A method comprising:
collecting, by a central processor application from a merchant processor, transaction profile information associated with an online transaction;
analyzing, by the central processor application, the transaction profile information;
determining, by the central processor application based on the analysis of the transaction profile information, a security assessment of the online transaction, wherein the security assessment indicates a measure of security associated with the online transaction;
generating, by the central processor application, a fraud responsibility transfer request;
transmitting the fraud responsibility transfer request to the merchant processor;
receiving, from the merchant processor, an acceptance response comprising an agreement to transfer a fraud responsibility to the central processor; and
performing, based on the acceptance response, a checkout process for the online transaction, wherein the merchant processor shifts the fraud responsibility to the central processor application.

12. The method of claim 11, wherein the security assessment comprises one or more security levels, comprising a high-risk level and a low-risk level.

13. The method of claim 12, wherein upon determining the high-risk level the central processor application rejects the online transaction.

14. The method of claim 12, wherein upon determining the low-risk level the central processor application requests the merchant processor to perform an expedited checkout process.

15. The method of claim 12, wherein upon determining a high-risk level the central processor application requests the merchant processor to provide one or more additional transaction details associated with the online transaction.

16. The method of claim 13, wherein upon determining a high-risk level the method further comprises:
transmitting, to a user device associated with the online transaction, an authentication request; and
receiving, from the user device, a user authentication credential.

17. The method of claim 11, wherein the central processor application is associated with one account provider.

18. The method of claim 11, wherein the central processor application is associated with a plurality of account providers, wherein each account provider comprises at least one transaction account associated with a user associated with the online transaction.

19. The method of claim 11, wherein transaction profile information includes one or more typing patterns or typing speeds.

20. A non-transitory computer readable medium containing computer executable instructions that, when executed by a device comprising a processor, cause the device to perform procedures comprising:
collecting, from a merchant processor, transaction profile information associated with an online transaction;
analyzing the transaction profile information;
determining, based on the analysis of the transaction profile information, a security assessment of the online transaction, wherein the security assessment indicates a measure of security associated with the online transaction;
generating a fraud responsibility transfer request;
transmitting the fraud responsibility transfer request to the merchant processor;
receiving, from the merchant processor, an acceptance response comprising an agreement to transfer a fraud responsibility; and
performing, based on the acceptance response, a checkout process for the online transaction, wherein the merchant processor shifts the fraud responsibility to an account provider.
